(19) United States
(12) Patent Application Publication
(10) Pub. No.: US 2010/0248085 A1
(43) Pub. Date: Sep. 30, 2010

(54) Flow field plate of a fuel cell with airflow guiding gaskets

(75) Inventors: Sun-Wei Chang, Taipei (TW); Chung-Wen Chih, Taipei (TW); Chu-Hsueh Yu, Taipei (TW); Yung-Ching Lin, Taipei (TW)

Correspondence Address: BACON & THOMAS, PLLC, 625 SLATERS LANE, FOURTH FLOOR, ALEXANDRIA, VA, 22314-1176, US

(73) Assignee: Tatung Company, Taipei (TW)

(21) Appl. No.: 12/458,616

(22) Filed: Jul. 17, 2009

(30) Foreign Application Priority Data
Mar. 25, 2009 (TW) 098109710

(51) Int. Cl. H01M 2/08

(52) U.S. Cl. 429/523

(57) ABSTRACT

The present invention relates to a flow field plate of a fuel cell with airflow guiding gaskets, comprising a flat plate and airflow guiding gaskets. Each side of the flat plate has a reaction area, which includes a plurality of ribs and a plurality of grooves. Two airflow guiding gasket are respectively covered on the two sides of the flat plate, and a central hollowed region of each airflow guiding gasket is corresponding to the reaction area. An inlet hole of the flat plate communicates with the hollowed region and each inlet of the grooves through an inlet trough of the airflow guiding gasket. An outlet hole of the flat plate communicates with the hollowed region and each outlet of the grooves through an outlet trough of the airflow guiding gasket. Thus, the present invention is capable of significantly reducing the volume of the fuel cell and lowering the weight.

### BACKGROUND OF THE INVENTION

1. Field of the Invention

This invention relates to a flow field plate of a fuel cell with airflow guiding gaskets, and particularly relates to a flow field plate of a fuel cell employing fluid fuel.

2. Description of Related Art

A fuel cell is a device capable of transforming the chemical energy stored in fuel and oxidation agent into electrical energy directly, and has advantages of high transforming efficiency, zero contamination, low noise, long life, and so on. Thus, the fuel cell can continue generating electrical power as long as the fuel and the oxidation agent are supplied to the fuel cell from outside continuously. According to the difference of electrolyte, the fuel cell can be divided into an alkaline fuel cell (AFC), a phosphoric acid fuel cell (PAFC), a melted carbonate fuel cell (MCFC), a solid oxidation fuel cell (SOFC), and a proton exchange membrane fuel cell (PEMFC).

However, the difference between a fuel cell and a battery is that the fuel cell does not store but only transforms energy. The fuel cell starts an oxidation-reduction reaction by catalyst and generates energy without burning hard. In addition, the fuel cell generates electrical energy directly form oxidation of fuel, increases its discharge current depending on the increased amount of the supplied fuel, and thus can generate electrical energy continuously without the problem of electricity draining or electricity charging as long as the fuel and oxygen are supplied continuously. If fuel cells are connected in series to form a fuel cell stack, the fuel cells can provide higher voltage and have higher energy density. Therefore, in fuel cells, the flowing of air and hydrogen is important. It is necessary to make gas flow through each cell's reaction surface uniformly.

As such, the gas flowing channel provided in a conventional fuel cell makes use of the flowing channel of a flow field plate as the gas flowing channel. Referring to FIGS. 11A and 11B, FIG. 11A is a schematic view of a conventional flow field plate and FIG. 11B is a cross-sectional view of the conventional flow field plate. As shown in the drawings, both sides of a conventional flow field plate 8 are provided with a plurality of serpentine flow channels 81, and are used for providing fuel and oxygen flowing. However, the zigzag and serpentine flow channels 81 of the conventional flow field plate 8 are formed by a metallic bulk with a mechanical process, such as drilling and cutting, according to the present technology.

Accordingly, the conventional flow field plate 8 must have enough thickness for maintaining its rigidness, accompanied by having heavier weight. It is disadvantageous to the fuel cell under the developing trend of pursuing reduction of the volume and weight. Further, after the conventional flow field plate 8 is assembled, while membrane electrode assemblies (MEA) are clamped and pressed in a two-by-two manner, the serpentine flow channels 81 cannot correspond completely, cannot be clamped and pressed symmetrically, and particularly cannot correspond at bending places, resulting in that contact resistance occurs at asymmetrical places and the efficiency of the fuel cell is affected.

Therefore, it is an urgent need in the industry to achieve a flow field plate of a fuel cell with tremendously reduced thickness, volume, and weight, while maintaining rigidness, simplifying producing process, and reducing cost.

### SUMMARY OF THE INVENTION

This invention relates to a flow field plate of a fuel cell with airflow guiding gaskets, comprising a flat plate and an airflow guiding gasket. The flat plate includes a front side and a reaction area. The reaction area is provided on the front side and comprises therein a plurality of ribs and a plurality of grooves, in which the plurality of ribs and the plurality of grooves are disposed in parallel with each other and each of the plurality of ribs is interposed between two adjacent grooves. Each groove includes an inlet and an outlet. The flat plate is further provided with an inlet hole and an outlet hole outside the reaction area. In addition, an airflow guiding gasket is covered on the front side of the flat plate. The center of the air guiding gasket is hollowed to provide a hollowed region. The hollowed region corresponds to the reaction area of the flat plate and has the same shape. In addition, the airflow guiding gasket is further hollowed to provide an inlet trough and an outlet trough. Wherein the inlet hole of the flat plate communicates with the hollowed region and each inlet of the plurality of grooves through the inlet trough, and the outlet hole of the flat plate communicates with the hollowed region and each outlet of the plurality of grooves through the outlet trough. Accordingly, this invention can greatly reduce the thickness, volume, and weight of the flow field plate, while simplifying producing process and reducing cost. Besides, the change of the flowing channel of the invention is more flexible. It is possible to change the distribution of flowing channels only by replacing the airflow guiding gasket, thereby changing the efficiency of generating electricity.

In the invention, the plurality of grooves of the flat plate are divided into at least two sets of flowing channels, and the inlet of each groove of each set of the flowing channels is located at the same side. The outlet of each groove and the inlet of each groove in each set of flowing channels, which is adjacent to but not in the same set of flowing channels, are at the same side. Further, the air flow guiding gasket is hollowed to provide with at least a flow guiding trough. The at least a flow guiding trough communicates between the outlet of each groove of one set of flowing channels and the inlet of each groove of an adjacent but not the same set of flowing channels. Based on this, the various distributions of fluid flowing channels, such as in a circuitous and zigzag way, are formed by changing the positions of the airflow guiding troughs, accompanied (mated) by the flowing channels, thereby changing the efficiency of generating electricity and achieving more flexible mating.

In addition, this invention further comprises a further airflow guiding gasket, and the flat plate further includes a back side opposite to the front side. A further reaction area is provided on the bask side and has further a plurality of ribs and further a plurality of grooves, which are parallel with one another. Each of the further a plurality of parallel ribs is provided between adjacent two of the further a plurality of grooves. Each of the further a plurality of grooves includes an inlet and an outlet. The flat plate is further provided with a further inlet hole and a further outlet hole. In addition, the further airflow guiding gasket is covered on the back side of the flat plate. The center of the further air guiding gasket is hollowed to provide a hollowed region. The hollowed region corresponds to the further reaction area of the flat plate and has the same shape. The further air flow guiding gasket is further hollowed to provide a further inlet trough and a further outlet trough. Inside it, the further inlet hole of the flat plate communicates with the hollowed region and the inlets of the further a plurality of grooves through the further inlet trough, and the further outlet hole of the flat plate communicates with the hollowed region and the outlets of the further plurality of grooves through the further outlet trough. Therefore, both sides of the flat plate may comprise the reaction areas for processing reaction simultaneously, thereby reducing the entire volume.

Preferably, the flat plate of this invention is a metal thin plate. Thus, the flat plate is formed by pressing such that the plurality of ribs of the reaction area correspond to the further plurality of grooves of the further a reaction area. Similarly, the plurality of grooves of the reaction area correspond to the further plurality of ribs of the further a reaction area. That is, the two sides of the flat plate of the invention may form at one time the plurality of ribs and grooves of the reaction areas correspondingly by pressing or other equivalent processes, thereby reducing the costs of production and materials, and decreasing the entire volume and weight significantly.

Besides, the flat plate may be a metal thin plate, a carbon plate, a complex material plate, or other equivalent thin plates. In addition, a surface of the flat plate may further include a gold plating layer. Further, the cross-sectional shapes of the plurality of grooves of the flat plate of this invention are respectively a trapezoid, a triangle, an arc, a rectangle, a polygon, or other equivalent shapes. The airflow guiding gaskets of this invention may be made of Viton, Teflon, rubber, or other equivalent materials.

### BRIEF DESCRIPTION OF THE DRAWINGS

FIG. 1 is an exploded diagram of a whole fuel cell according to a preferred embodiment of the invention;

FIG. 2A is a three-dimensional diagram of an airflow guiding gasket according to a preferred embodiment of the invention;

FIG. 2B is a front side three-dimensional diagram of a flat plate according to a preferred embodiment of the invention;

FIG. 2C is a back side three-dimensional diagram of a flat plate according to a preferred embodiment of the invention;

FIG. 2D is a three-dimensional diagram of further an airflow guiding gasket according to a preferred embodiment of the invention;

FIG. 3 is a schematic diagram of a combination of a flat plate and an airflow guiding gasket according to a preferred embodiment of the invention;

FIG. 4 is a cross-sectional diagram according to a preferred embodiment of the invention;

FIG. 5 is a schematic view of a combination of a flat plate and an airflow guiding gasket according to a second embodiment of the invention;

FIG. 6 is a three-dimensional diagram of further a configuration of an airflow guiding gasket according to the invention;

FIG. 7 is a cross-sectional diagram of further a configuration of a flat plate according to the invention;

FIG. 8 is a cross-sectional diagram of still further a configuration of a flat plate according to the invention;

FIG. 9 is a cross-sectional diagram of still furthermore a configuration of a flat plate according to the invention;

FIG. 10 is a three-dimensional diagram of a whole airflow fuel cell according to a preferred embodiment of the invention;

FIG. 11A is a schematic view of a conventional flow field plate;

FIG. 11B is a cross-sectional diagram of a conventional flow field plate.

### DETAILED DESCRIPTION OF THE PREFERRED EMBODIMENT

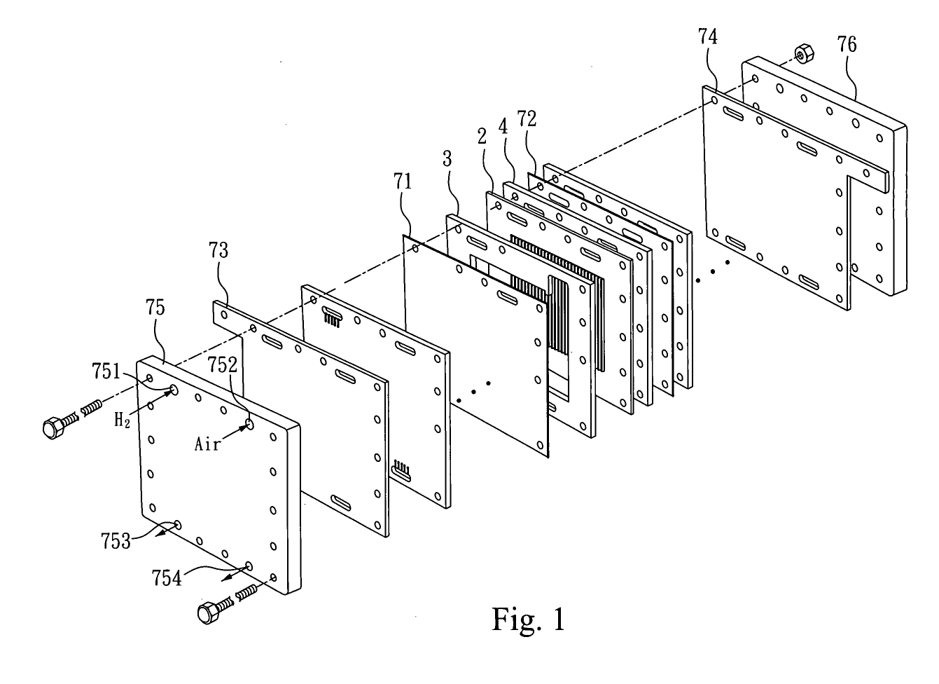

Please refer to FIG. 1. FIG. 1 is an exploded diagram of a whole fuel cell according to a preferred embodiment of the invention. The fuel cell of this invention mainly comprises a front plate 75, a back plate 76 and a plurality of flat plates 2. The plurality of flat plates 2 are disposed between the front plate 75 and the back plate 76. Further, a front collector plate 73 and a back collector plate 74 are respectively disposed between the inner side of the front plate 75 and the plurality of flat plates 2 and between the back plate 76 and the plurality of flat plates 2 for collecting current and transferring it to a load through an external circuit. Both sides of each of the flat plates 2 have an airflow guiding gasket 3 and an airflow guiding gasket 4, respectively. In addition, a membrane electrode assembly 71 and a membrane electrode assembly 72 are disposed at the other side of the airflow guiding gasket 3 and the other side of the airflow guiding gasket 4, respectively.

However, the airflow guiding gaskets 3, 4 are mainly used for air sealing and airflow guiding. The membrane electrode assembly is a key part of the fuel cell and is a core element for transferring chemical energy into electrical energy. It has a multi-layered structure stacked by a gas diffusing layer, catalyst and a proton exchanging membrane. Besides, the front plate 75 and the back plate 76 are not only used for clamping and supporting, but also used for providing flowing channels for entering air and fueling air into the cell. Thus, an air inlet 752, an air outlet 753, a hydrogen inlet 751, and a hydrogen outlet 754 are provided on the front plate 75 and used as channels for respectively passing air and hydrogen in and out of the cell.

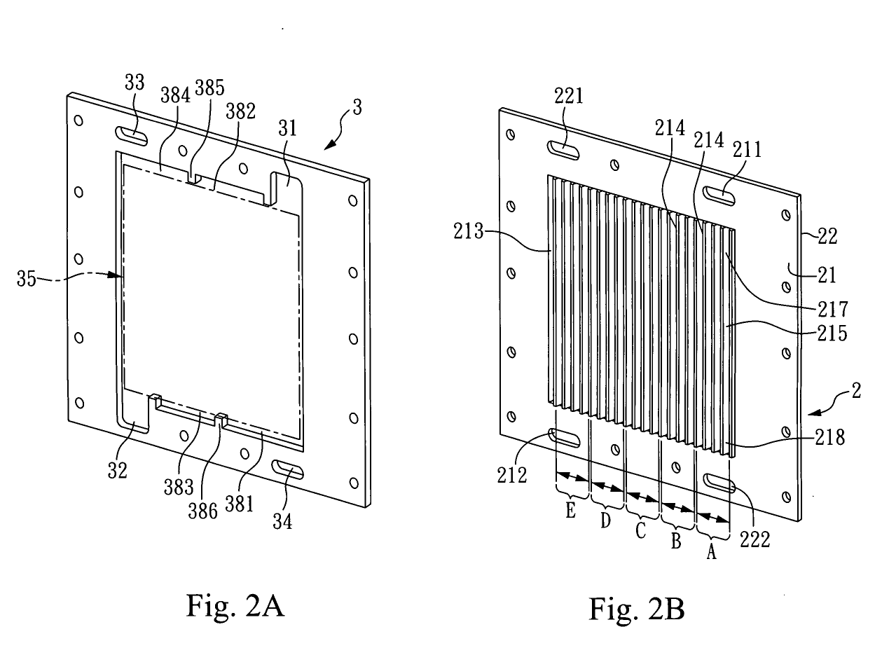

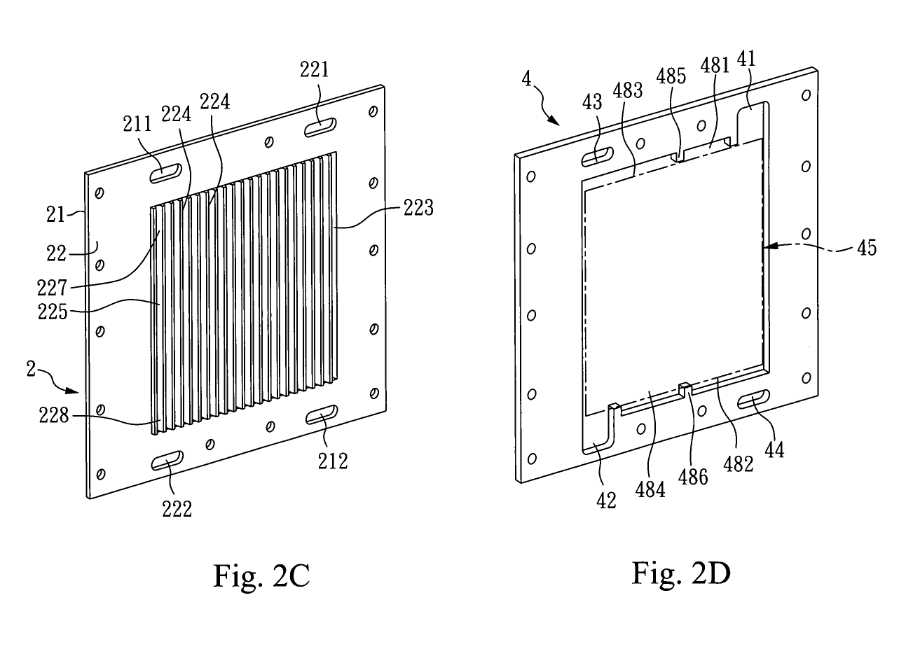

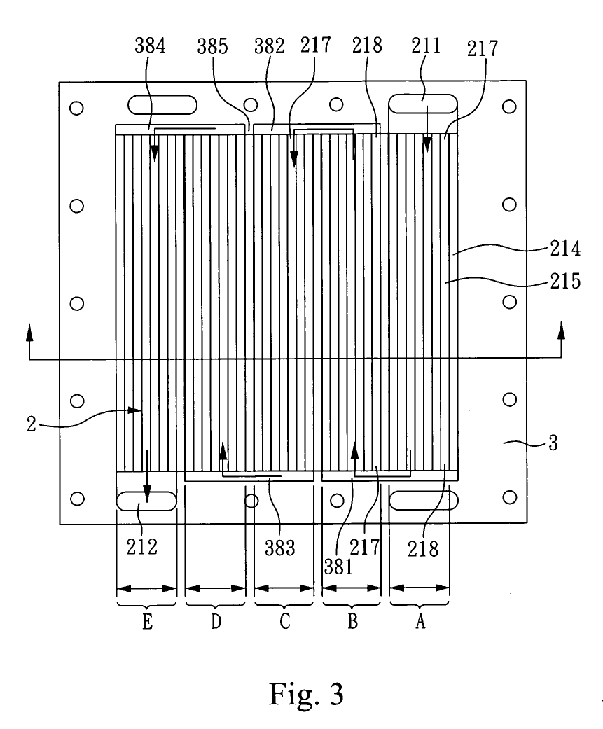

Please refer to FIGS. 2A, 2B, and 3 concurrently. FIG. 2A is a three-dimension diagram of an airflow guiding gasket according to a preferred embodiment of a flow field plate of a fuel cell with airflow guiding gaskets of the invention, FIG. 2B is a front side three-dimension diagram of a flat plate according to a preferred embodiment of the invention, and FIG. 3 is a schematic diagram of a combination of a flat plate and an airflow guiding gasket according to a preferred embodiment of the invention. In the drawings, a flat plate comprises a front side 21 and a back side 22. The front side 21 includes a reaction area 213, and the reaction area 213 comprises a plurality of ribs 214 and a plurality of grooves 215, in which the plurality of ribs 214 and the plurality of grooves 215 are disposed in parallel with one another and each of the plurality of ribs 214 is interposed between two adjacent grooves 215. Each groove 215 includes an inlet 217 and an outlet 218.

In addition, the plurality of grooves 215 of the flat plate 2 of this embodiment are divided into five sets of flowing channels, A, B, C, D, and E. The inlet 217 of each groove 215 of each set of the flowing channels is located at the same side. The outlet 218 of each groove 215 in each set of flowing channels A and the inlet 217 of each grooves 215 in the set of flowing channels B, which is different and adjacent to the set of flowing channels A, are at the same side. The flat plate 2 is further provided with an inlet hole 211 and an outlet hole 212 outside the reaction area 213. The inlet hole 211 communicates with the air inlet 752, and the outlet hole 212 communicates with the air outlet 753.

Besides, FIG. 2A further shows that an airflow guiding gasket 3 is provided to cover the front side 21 of the flat plate 2. The center of the airflow guiding gasket 3 is hollowed to provide a hollowed region 35, and the hollowed region 35 corresponds to the reaction area 213 of the flat plate 2 and has the same shape. The air flow guiding gasket 3 is further hollowed to provide an inlet trough 31 and an outlet trough 32. The inlet hole 211 of the flat plate 2 communicates with the hollowed region 35 and the inlet 217 of the plurality of grooves 215 through the inlet trough 31, and the outlet hole 212 of the flat plate 2 communicates with the hollowed region 35 and the outlets 218 of the plurality of grooves 215 through the outlet trough 32.

In addition, the airflow guiding gasket 3 is further hollowed to provide four airflow guiding troughs 381, 382, 383, and 384. The airflow guiding trough 381 communicates between the outlet 218 of each groove 215 in one set of flowing channels A of above sets of flowing channels and the inlet 217 of each groove 215 in the set of flowing channels B, which is different and adjacent to the set of flowing channels A. Or, the airflow guiding trough 382 communicates between the outlet 218 of each groove 215 in the set of flowing channels B and the inlet 217 of each groove 215 in the set of flowing channels C, and the rest may be inferred by analogy. Whereby, the circuitous and zigzag distributions of flowing channels are formed to increase the efficiency of the fuel cell.

Please refer to FIGS. 2C and 2D together. FIG. 2C is a back side three-dimensional diagram of a flat plate according to a preferred embodiment of a flow field plate of a fuel cell with airflow guiding gaskets of the invention, and FIG. 2D is a three-dimensional diagram of further an airflow guiding gasket according to a preferred embodiment of the invention. A back side 22 of the flat plate 2 and further an airflow guiding gasket 4 are shown in the drawings. The back side 22 is located at the corresponding back side of the front side 21 and is provided with further a reaction area 223. The further a reaction area 223 is provided therein with further a plurality of ribs 224 and further a plurality of grooves 225, which are disposed in parallel with one another, and each of the further a plurality of ribs 224 is interposed between two of the further a plurality of grooves 225. Each of the further a plurality of grooves 225 includes an inlet 227 and an outlet 228. The plate 2 is further pierced to provide further an inlet hole 221 and further an outlet hole 222. The inlet hole 221 communicates with the hydrogen inlet 751, and the outlet hole 222 communicates with the hydrogen outlet 754.

Besides, the further an airflow guiding gasket 4 is covered on the back side 22 of the flat plate 2. The further an air guiding gasket 4 is hollowed to provide a hollowed region 45. The hollowed region 45 corresponds to the further a reaction area 223 of the flat plate 2 and has the same shape. The further an air flow guiding gasket 4 is further hollowed to provide further an inlet trough 41 and further an outlet trough 42. The further an inlet hole 221 of the flat plate 2 communicates with the hollowed region 45 and the inlet 227 of the further a plurality of grooves 225 through the further an inlet trough 41, and the further an outlet hole 222 of the flat plate 2 communicates with the hollowed region 45 and outlets 228 of the further a plurality of grooves 225 through the further an outlet trough 42. Similarly, the air guiding gasket 3 is further hollowed to provide four airflow guiding troughs 481, 482, 483, and 484 for airflow guiding so as to form circuitous and zigzag distributions of flowing channels.

In addition, the flat plate 2 of this embodiment is a metal thin plate, i.e. an aluminum plate with its surface plated with gold. Thus, the flat plate 2 is formed by pressing such that the plurality of ribs 214 of the reaction area 213 of the front side 21 correspond to the plurality of grooves 225 of the further a reaction area 223 of the back side 22. Similarly, the plurality of grooves 215 of the reaction area 213 of the front side 21 correspond to the plurality of ribs 224 of the further a reaction area 223 of the back side 22. That is, the two sides of the flat plate 2 of the invention may be correspondingly formed at one time the plurality of ribs 214, 224, and the plurality of grooves 215, 225 of the reaction areas 213, 223 through pressing or other equivalent processes, thereby significantly reducing the costs of manufacturing production and materials and significantly decreasing the entire volume and weight.

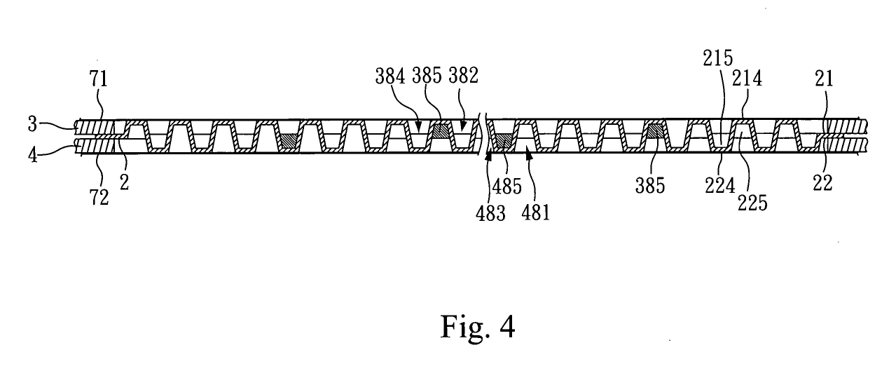

Please refer to FIG. 4. FIG. 4 is a cross-sectional view of a flow field plate of a fuel cell with airflow guiding gaskets according to a preferred embodiment of this invention. As shown in the drawing, a membrane electrode assembly 71, 72 is respectively attached and sealed on the front side 21 and back side 22 of the flat plate 2 in view from a trapezoid cross-section. The drawing further shows that a separating wall 385 is provided between the airflow guiding trough 382 and the airflow guiding trough 384 of the front side 21. Similarly, a separating wall 485 is provided between the airflow guiding trough 481 and the airflow guiding trough 483 of the back side 22. The separating walls 384, 385 are mainly used for blocking airflow and forming airflow guiding. That is, the flow direction of the right side of the separating wall 385 (airflow guiding trough 382) is flowing out from the paper, and the flow direction of the left side of the separating wall 385 (airflow guiding trough 384) is flowing into the paper. Similarly, the flow direction of the left side of the separating wall 485 (airflow guiding trough 483) is flowing into the paper, and the flow direction of the right side of the separating wall 485 (airflow guiding trough 481) is flowing out from the paper.

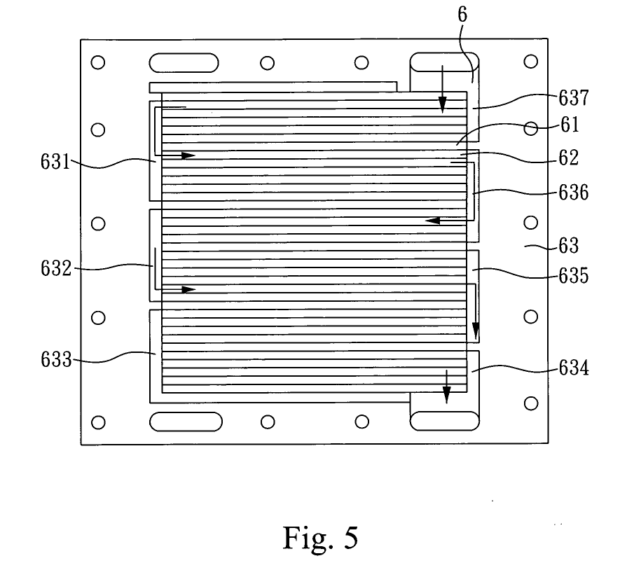

Please refer to FIG. 5. FIG. 5 is a schematic view of a combination of a flat plate and an airflow guiding gasket according to a second embodiment of a flow filed plate of a fuel cell with airflow guiding gaskets of the invention. The major difference between the second embodiment and the first embodiment is that the direction of the plurality of ribs 61, the plurality of grooves 62, and the airflow guiding troughs 631, 632, 633, 634, 635, 636, and 637 of the airflow guiding gasket 63 of the second embodiment is different from that of the first embodiment, and exactly differs in 90 degrees. The embodiment is mainly used to show that the plurality of ribs 61 and the plurality of grooves 62 in the reaction area of the flat plates 2, 6 may be flow channels of any angle and shape, and can form various distributions of flow channels according to different requirements, accompanied by the corresponding airflow guiding gasket, thereby flexibly changing the efficiency of generating electric power.

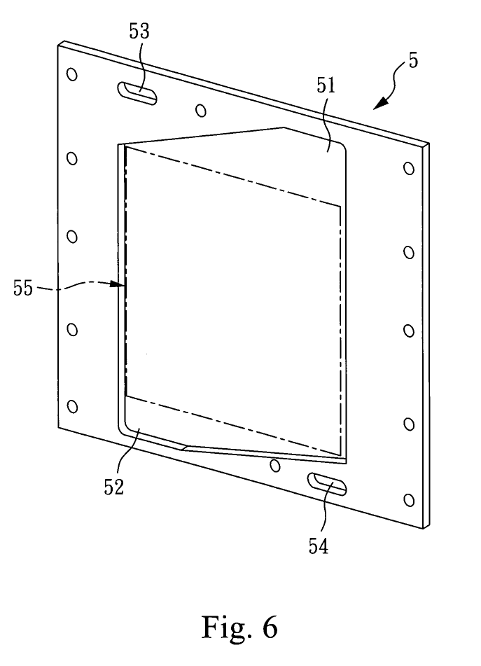

Please refer to FIG. 6. FIG. 6 is a is a three-dimensional diagram view of an airflow guiding gasket for a flow field plate of a fuel cell with airflow guiding gaskets according to further a configuration of this invention. As shown, no airflow guiding troughs are provided in the hollowed area 55 of the airflow guiding gasket 5, while an inlet trough 51 and an outlet trough 52 are extended to gradually cover the whole hollowed area 55 directly. That is, after air or hydrogen enters the hollowed area 55 through the inlet trough 51, the air or hydrogen passes through the flow channels of the mating flat plate (not shown in the drawing) and directly flows out through the outlet trough 52 without passing the circuitous and zigzag flow channels of the airflow guiding trough. Of course, the mating flow channels of the flat plate may be in any form.

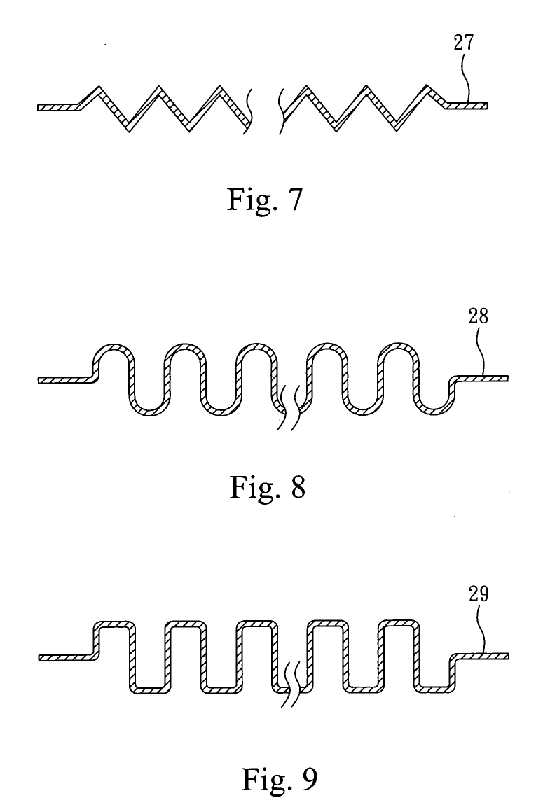

Please refer to FIGS. 7, 8, and 9 together. The drawings show various available forms of the flat plates 27, 28, and 29 according to this invention. The cross-sectional shape of the flat plate 27 in FIG. 7 is a triangle, the cross-sectional shape of the flat plate 28 in FIG. 8 is an arc, and the cross-sectional shape of the flat plate 29 in FIG. 9 is a rectangle. Of course, the different cross-sections of the flat plates require to mate different airflow guiding gaskets, especially the cross-sectional shape of the separating wall. Besides, the airflow guiding gasket 3 of this embodiment is an airflow guiding gasket made of Viton. Of course, the airflow guiding gasket may be made of Teflon, rubber, or other equivalent materials.

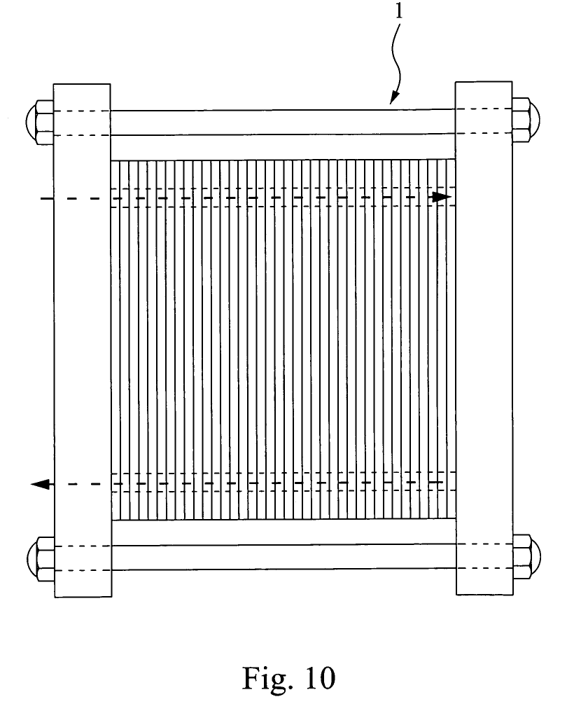

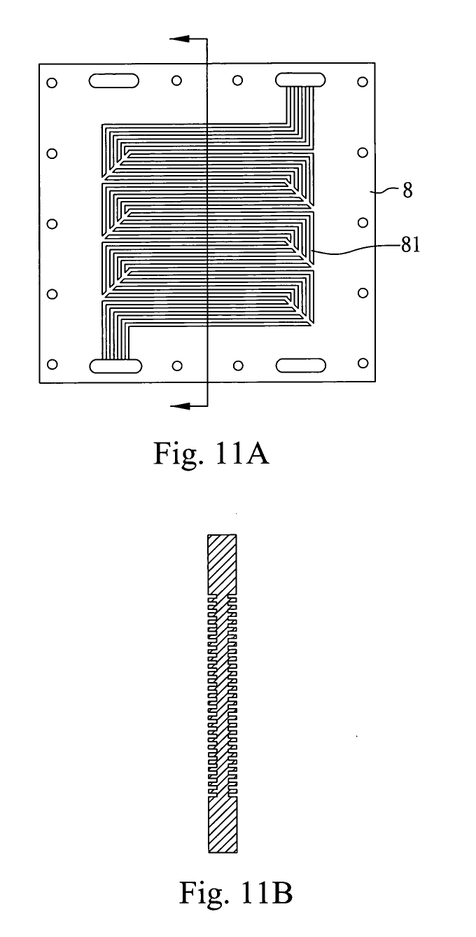

Please refer to FIG. 10. FIG. 10 is a three-dimensional diagram of a whole airflow fuel cell according to a preferred embodiment of the flow field plate of a fuel cell with airflow guiding gaskets of this invention. The drawing shows a combination of a whole fuel cell 1. The thickness of the flat plate according to the first embodiment of the invention is only 0.12 mm. In comparison, the thickness of a conventional flat plate is 2 mm. Accordingly, in the fuel cell of this invention, the total volume is 280 cm³ and the total weight is 365 gms. However, in the conventional fuel cell, the total volume is 350 cm³ and the weight is 895 gms. As compared with the conventional fuel cell, the volume of the fuel cell according to the invention reduces about 20% and the weight reduces about 60%. The effects are evidently knowable. Further, the distributions of flow channels may be changed flexibly through mating of the flat plates 2, 27, 28, 29, and 6 and the airflow guiding gaskets 3, 4, 5, and 63, thereby changing the efficiency of the fuel cell 1. Besides, according to the invention, the flat plates 2, 27, 28, 29, and 6 may correspond completely, be clamped and pressed symmetrically, and produce no contact resistance.

Although the present invention has been explained in relation to the preferred embodiments, it is to be understood that many other possible modifications and variations can be made without departing from the scope of the invention as hereinafter claimed.

What is claimed is:

1. A flow field plate of a fuel cell with airflow guiding gaskets, comprising:
a flat plate, including a front side and a reaction area, the reaction area being provided on the front side and comprising a plurality of ribs and a plurality of grooves, in which the plurality of ribs and the plurality of grooves are disposed in parallel with one another and each of the plurality of ribs is interposed between two adjacent grooves, each groove including an inlet and an outlet, and the flat plate being further provided with an inlet hole and an outlet hole outside the reaction area; and
an airflow guiding gasket, being covered on the front side of the flat plate, the air guiding gasket being hollowed to provide a hollowed region, the hollowed region corresponding to the reaction area of the flat plate and having the same shape, and the air flow guiding gasket being further hollowed to provide an inlet trough and an outlet trough,
wherein the inlet hole of the flat plate communicates with the hollowed region and each inlet of the plurality of grooves through the inlet trough, and the outlet hole of the flat plate communicates with the hollowed region and each outlet of the plurality of grooves through the outlet trough.

2. The flow field plate of a fuel cell with airflow guiding gaskets according to claim 1, wherein the plurality of grooves of the flat plate are divided into at least two sets of flowing channels, the inlet of each groove of each set of the flowing channels is located at the same side, and in each set of flowing channels, the outlet of each groove and the inlet of each grooves, which are adjacent to but not in the same set of flowing channels, are at the same side; and
wherein the air flow guiding gasket is hollowed to provide at least a flow guiding trough, and the at least a flow guiding trough communicates between the outlet of each groove of one set of flowing channels and the inlet of each groove, which is adjacent to but not in the same set of flowing channels.

3. The flow field plate of a fuel cell with airflow guiding gaskets according to claim 1, further comprising a further airflow guiding gasket, wherein the flat plate further includes a back side opposite to the front side, a further reaction area is provided on the bask side and has further a plurality of ribs and further a plurality of grooves, which are parallel with one another, each of the further a plurality of parallel ribs is provided between adjacent two of the further a plurality of grooves, each of the further a plurality of grooves includes an inlet and an outlet, and the flat plate is further provided with a further inlet hole and a further outlet hole;
the further airflow guiding gasket being covered on the back side of the flat plate, the further air guiding gasket being hollowed to provide a hollowed region, the hollowed region corresponding to the further reaction area of the flat plate and having the same shape, and the further air flow guiding gasket being further hollowed to provide a further inlet trough and a further outlet trough,
wherein the further inlet hole of the flat plate communicates with the hollowed region and each inlet of the further a plurality of grooves through the further inlet trough, and the further outlet hole of the flat plate communicates with the hollowed region and each outlet of the further plurality of grooves through the further outlet trough.

4. The flow field plate of a fuel cell with airflow guiding gaskets according to claim 3, wherein the plurality of ribs in the reaction area correspond to the plurality of grooves of the further a reaction area, and the plurality of grooves of the reaction area correspond to the plurality of ribs of the further a reaction area.

5. The flow field plate of a fuel cell with airflow guiding gaskets according to claim 1, wherein the flat plate is a metal thin plate.

6. The flow field plate of a fuel cell with airflow guiding gaskets according to claim 1, wherein a surface of the flat plate further includes a gold-plating layer.

7. The flow field plate of a fuel cell with airflow guiding gaskets according to claim 1, wherein the shape in cross-section of each of the plurality of grooves of the flat plate is trapezoid.

8. The flow field plate of a fuel cell with airflow guiding gaskets according to claim 1, wherein the airflow guiding gasket is a Viton airflow guiding gasket.
